(19) United States
(12) Patent Application Publication
(10) Pub. No.: US 2024/0366026 A1
(43) Pub. Date: Nov. 7, 2024

(54) APPARATUS AND METHODS FOR MELTING CHOCOLATE OR LIKE SUBSTANCES

(71) Applicant: Encocoa LLC, Federal Way, WA (US)

(72) Inventors: Dawn F. Meader McCausland, Federal Way, WA (US); Hoan-vu P. Tran, Federal Way, WA (US)

(21) Appl. No.: 18/654,875

(22) Filed: May 3, 2024

Related U.S. Application Data
(60) Provisional application No. 63/464,502, filed on May 5, 2023.

(51) Int. Cl. A47J 36/16; A47J 27/12

(52) U.S. Cl. CPC A47J 36/16; A47J 27/12

(57) ABSTRACT

Embodiments are directed to apparatus and methods for melting chocolate or like substances. A vessel holding device for holding a vessel of chocolate or like substances and enabling the chocolate or like substances to be melted therein is disclosed. The vessel holding device may comprise: a surface structure configured to hold the vessel; and a hole in the surface structure configured to receive part of the vessel in a downward vertical direction through the hole, wherein the surface structure has a horizontal length that is at least as large as a top opening of a hot water receptacle on which the surface structure is configured to be placed and in which the vessel is configured to be suspended when held by the surface structure.

### BRIEF SUMMARY

Cacao has been ingested by humans for thousands of years. It was originally prepared as a drink. Cacao beans are combined with sugar to make chocolate and prepared in many different ways in modern society. Chocolate consumption is most often enjoyed in the form of a solid bar, a semisolid confection, or hot cocoa. Another way of enjoying chocolate is in its melted form.

Fondue, from the French word fondre, (“to melt”), has been a way to consume melted cheese mixed with other ingredients for hundreds of years. More recently, the fondue method has been applied to chocolate: heating chocolate, sometimes with cream, milk, oils, and/or alcohol, to make a dipping sauce. Fondue is commercially available in restaurants, using active heating methods such as hot plates or gas burners. Home fondue pots and kits also have active heating methods and are encumbered with stands and utensils that make enjoying fondue more expensive and less portable.

Therefore, a simple, portable solution for enjoying fondue using hot water is desirable.

An apparatus for melting chocolate or like substances is disclosed. Various embodiments include a supportive vessel holding device for suspending a vessel of chocolate or other like substances over a receptacle of hot water to melt the chocolate. This vessel holding device can be placed on top of, or around the rim of, a hot water receptacle to suspend the vessel of chocolate inside the hot water receptacle. In another embodiment, the vessel holding device may comprise a seal along the inner perimeter of a hole in the device to create a seal with the vessel it is holding. In further embodiments, the vessel holding device may have a gasket, seal or textile on the underside of the device or on the outer perimeter of the device to create a seal with the hot water receptacle on which it is placed.

In another embodiment, support struts are attached to the bottom of the vessel holding device to contain and hold a vessel of chocolate or like substances. The vessel holding device may have a plurality of shapes for the inner and outer perimeter.

In another example embodiment, a vessel holding device is disclosed for holding a vessel of chocolate or like substances and enabling the chocolate or like substances to be melted therein. In the example embodiment, the vessel holding device may comprise: a surface structure configured to hold the vessel; and a hole in the surface structure configured to receive part of the vessel in a downward vertical direction through the hole, wherein the surface structure has a horizontal length that is at least as large as a top opening of a hot water receptacle on which the surface structure is configured to be placed and in which the vessel is configured to be suspended when held by the surface structure.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a top view of vessel holding device showing a hole within the disc in accordance with an example embodiment of the present disclosure.

FIG. 2 illustrates a perspective view of the vessel holding device, showing one hole within the vessel holding device in accordance with an example embodiment of the present disclosure.

FIG. 3 illustrates a perspective view of the vessel holding device, showing two holes to hold two different vessels.

FIG. 4 illustrates perspective cross section view, showing a seal attached to the inner perimeter of the hole in the vessel holding device, and a seal on the bottom surface of the vessel holding device in accordance with an example embodiment of the present disclosure.

FIG. 5 illustrates a perspective cross section showing supporting struts attached to the inner perimeter of the hole in the vessel holding device in accordance with an example embodiment of the present disclosure.

FIG. 6 illustrates a perspective cross section showing supporting struts attached to the underside of the vessel holding device in accordance with an example embodiment of the present disclosure.

FIG. 7 illustrates a top perspective view of a vessel holding device holding a vessel of chocolate in accordance with an example embodiment of the present disclosure.

FIG. 8 illustrates a side perspective view of the vessel holding device of FIG. 7 holding a vessel of chocolate in accordance with an example embodiment of the present disclosure.

FIG. 9 illustrates a top perspective view of the vessel holding device of FIG. 7 that is removably placed on hot water receptacle and is suspending a vessel of chocolate in the hot water receptacle in accordance with an example embodiment of the present disclosure.

FIG. 10 illustrates a top perspective view of a vessel holding device holding a vessel of chocolate in accordance with another example embodiment of the present disclosure.

FIG. 11 illustrates a top perspective view of the vessel holding device of FIG. 10 that is removably placed on hot water receptacle and is suspending a vessel of chocolate in the hot water receptacle in accordance with an example embodiment of the present disclosure.

FIG. 12 illustrates a top perspective view of the vessel holding device of FIG. 10 that is removably placed on hot water receptacle and is suspending a vessel of chocolate with a lid on the vessel of chocolate in accordance with an example embodiment of the present disclosure.

FIG. 13 illustrates a top perspective view of a vessel holding device that is removably placed on hot water receptacle and is suspending a vessel of chocolate that has a lid on the vessel of chocolate in accordance with another example embodiment of the present disclosure.

FIG. 14 illustrates a top perspective view of a vessel holding device formed from a lid of a hot water receptacle and holding a vessel of chocolate in accordance with another example embodiment of the present disclosure.

FIG. 15 illustrates a top perspective view of a vessel holding device of FIG. 14 formed from a lid of the hot water receptacle that is removably placed on the hot water receptacle and is suspending a vessel of chocolate in the hot water receptacle, having a lid on the vessel, in accordance with an example embodiment of the present disclosure.

FIG. 16 illustrates a top perspective view of a vessel holding device of FIG. 14 formed from a lid of the hot water receptacle that is removably placed on the hot water receptacle and is suspending the vessel of chocolate in the hot water receptacle, without the lid on the vessel, in accordance with an example embodiment of the present disclosure.

FIG. 17 illustrates a bottom perspective view of the vessel holding device of FIG. 14 formed from a lid of a hot water receptacle and holding a vessel of chocolate in accordance with another example embodiment of the present disclosure.

FIG. 18 illustrates a top perspective view of a vessel holding device that is a hot water receptacle and is suspending a vessel of chocolate in the hot water receptacle in accordance with another example embodiment of the present disclosure.

FIG. 19 illustrates a top perspective view of the vessel holding device of FIG. 18 that is a hot water receptacle showing the vessel of chocolate being removed from the vessel holding device in accordance with an example embodiment of the present disclosure.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure have not been shown or described in order to avoid unnecessarily obscuring descriptions of the embodiments. Additionally, the various embodiments may be methods, systems or devices.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Various embodiments are directed to apparatus and methods for heating and melting chocolate or other like semisolid substances, like cheese, etc.

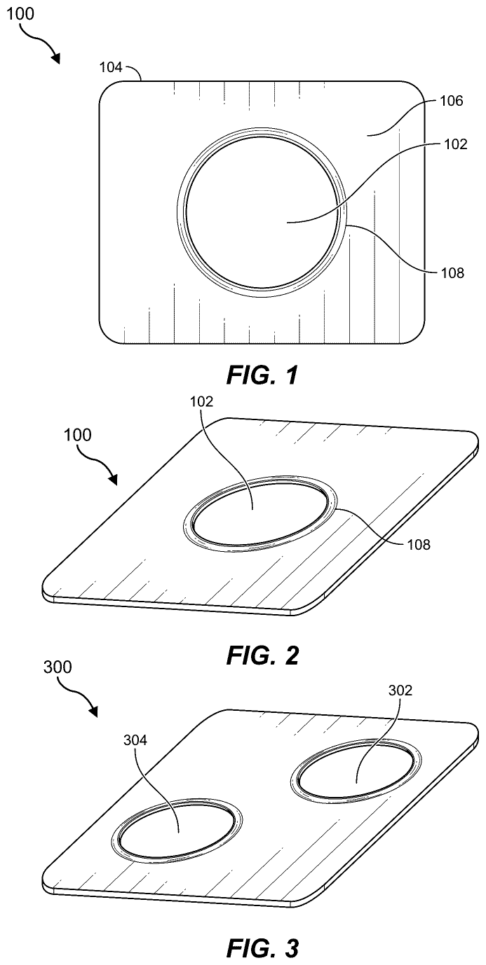

FIG. 1 illustrates a top view of vessel holding device 100 showing a hole 102 within the structure 104 in accordance with an example embodiment of the present disclosure and FIG. 2 illustrates a perspective view of the vessel holding device 100, showing one hole 102 within the vessel holding device 100 in accordance with an example embodiment of the present disclosure. FIG. 3 illustrates a perspective view of a vessel holding device 300, showing two holes (hole 302 and hole 304) within the vessel holding device 300 in accordance with an example embodiment of the present disclosure.

One example embodiment includes a structure 104 comprising a planar surface 106 that contains a hole 102 (or one or more holes, such as hole 302 and hole 304 shown in FIG. 3), that may each have one of a plurality of shapes, which allows partial pass-through of one or more respective vessels containing chocolate or like substances. The structure 104 may have a plurality of shapes and may be placed on the top opening of a receptacle for holding hot water (e.g., on top of an open cup or jar). The structure 104 has a planar surface 106, a top and bottom. For example, see FIGS. 1-17.

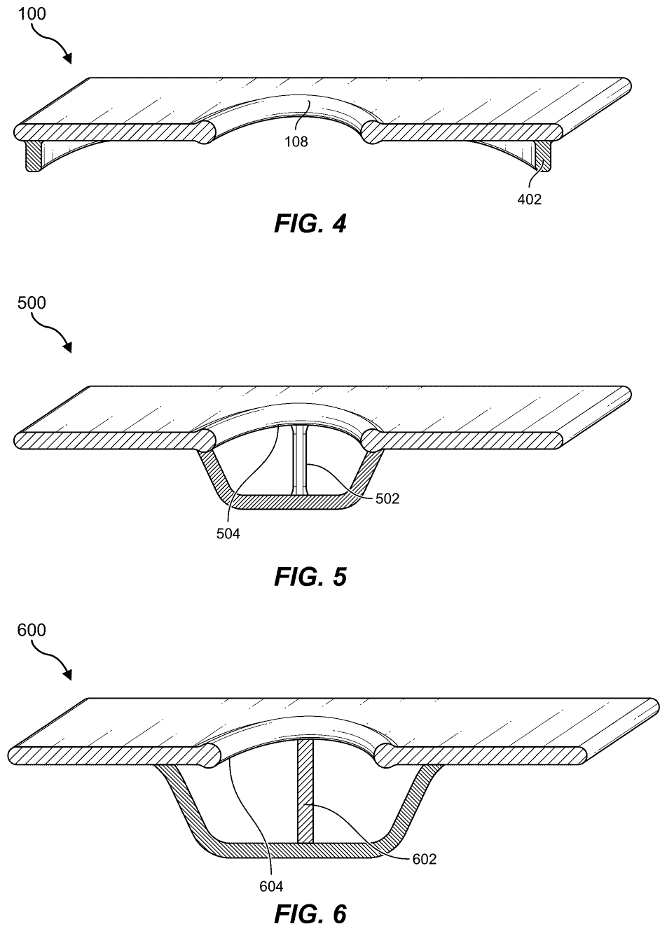

An embodiment of the invention may include a gasket or seal 108 along the inner perimeter of the hole 102 to improve grip or contact with the vessel (e.g., see FIG. 4). The seal 108 may be symmetric or asymmetric to fit the particular shape of the vessel it receives.

FIG. 4 illustrates perspective cross section view, showing a seal 108 attached to the inner perimeter of the hole in the vessel holding device 100, and a seal 402 on the bottom surface of the vessel holding device 100 in accordance with an example embodiment of the present disclosure.

For example, an embodiment may include a seal 402 on the bottom of the planar surface of the vessel holding device 100 to create a seal with the hot water receptacle on which the device 100 may be placed. The seal 402 may be attached to the outer perimeter or somewhere within the outer perimeter on the underside of the vessel holding device 100.

FIG. 5 illustrates a perspective cross section view of a vessel holding device 500 showing supporting struts 502 attached to the inner perimeter 504 of the hole in the vessel holding device 500 in accordance with an example embodiment of the present disclosure and FIG. 6 illustrates a perspective cross section view of a vessel holding device 600 showing supporting struts 602 attached to the underside 604 of the vessel holding device 600 in accordance with an example embodiment of the present disclosure.

For example, another embodiment may include support struts, such as support struts 502 or support struts 602, or basket or cradle attached to the inner perimeter 504 or somewhere beyond the inner perimeter under the planar surface of the vessel holding device 600, such as, for example, attached to the underside 604 of the vessel holding device 600.

These embodiments are directed to holding a vessel of chocolate or like substance within a vessel holding device (e.g., within a disc shaped structure) and placing its entirety over a receptacle of hot water, suspending or submersing the vessel in hot water. The seal 108 on the inner perimeter and seal 402 on the other perimeter are configured to keep the heat and the steam within the hot water receptacle, maintain temperature and steam pressure to heat and melt the chocolate.

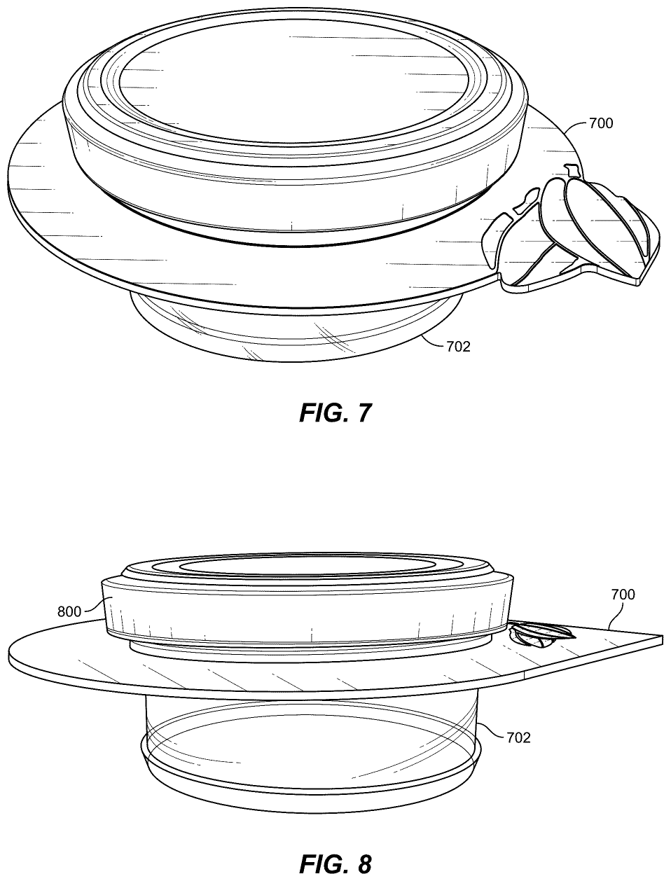

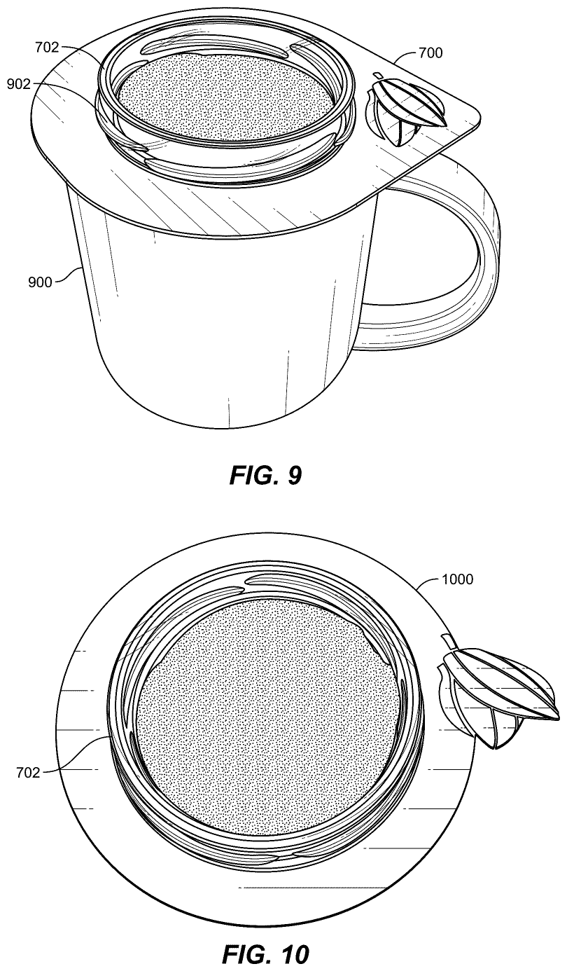

FIG. 7 illustrates a top perspective view of a vessel holding device 700 holding a vessel of chocolate 702 in accordance with an example embodiment of the present disclosure and FIG. 8 illustrates a side perspective view of the vessel holding device 700 of FIG. 7 holding the vessel of chocolate 702 in accordance with an example embodiment of the present disclosure. FIG. 9 illustrates a top perspective view of the vessel holding device 700 of FIG. 7 that is removably placed on hot water receptacle and is suspending the vessel of chocolate 702 in the hot water receptacle 900 in accordance with an example embodiment of the present disclosure. As shown in FIGS. 7, 8 and 9, the vessel holding device 700may sit on top of a rim of a receptacle 900 containing hot water (e.g., a jar or cup) without attaching to it.

In one example embodiment, the chocolate vessel 702 is suspended only from a part of the top of vessel 702 that is larger than the bottom of the vessel 702 (such as the vessel being a tapered jar or is suspended via the threading 902 for the jar lid 800).

FIG. 10 illustrates a top perspective view of a vessel holding device 1000 holding a vessel of chocolate 702 in accordance with another example embodiment of the present disclosure. In particular, the vessel holding device 1000 shown in FIG. 10 has a more circular shape than that of FIG. 9.

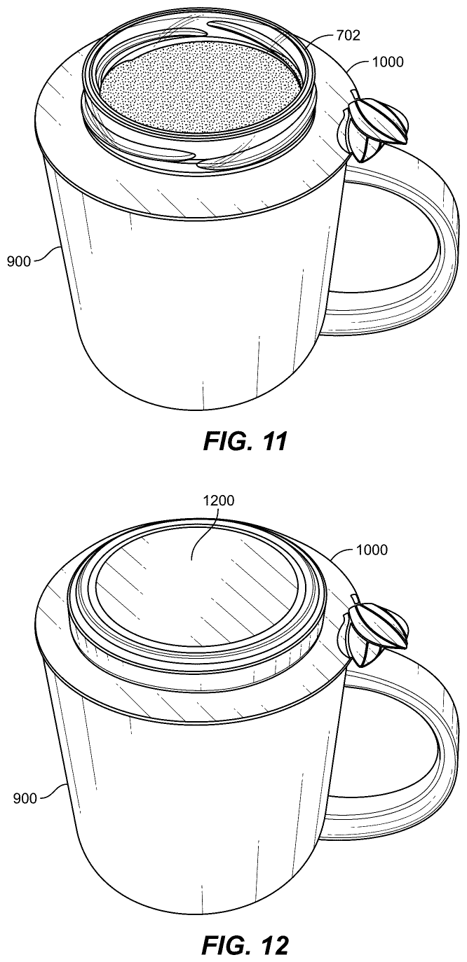

FIG. 11 illustrates a top perspective view of the vessel holding device 1000 of FIG. 10 that is removably placed on the hot water receptacle 900 and is suspending a vessel of chocolate 702 in the hot water receptacle 900 in accordance with an example embodiment of the present disclosure and FIG. 12 illustrates a top perspective view of the vessel holding device 1000 of FIG. 10 that is removably placed on the hot water receptacle 900 and is suspending the vessel of chocolate 702 with a lid 1200 on the vessel of chocolate 702 in accordance with an example embodiment of the present disclosure.

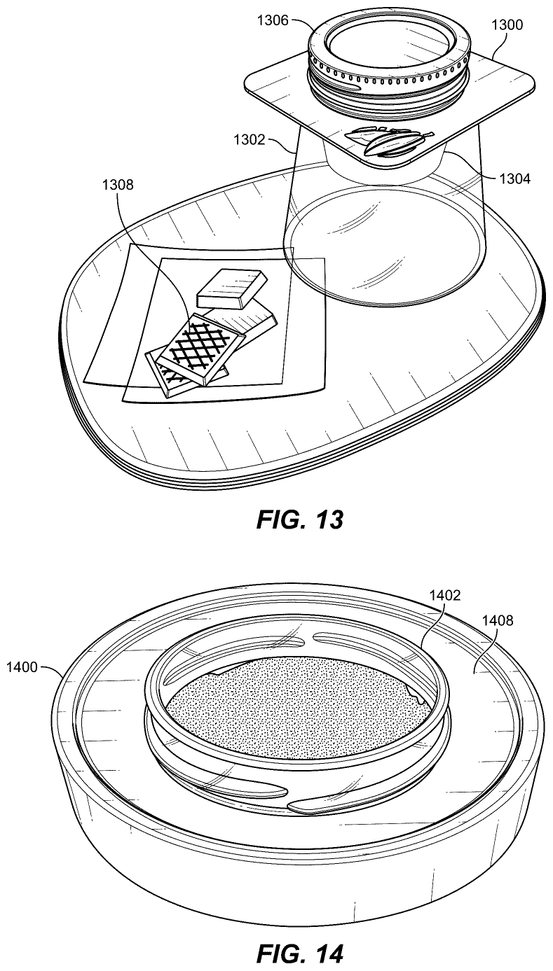

FIG. 13 illustrates a top perspective view of a vessel holding device 1300 that is removably placed on a different hot water receptacle 1302 that is clear and is suspending a vessel of chocolate 1304. The vessel of chocolate 1304 has a jar lid 1306 screwed on it in accordance with another example embodiment of the present disclosure. Shown are samples of chocolate 1308 which may be placed inside the vessel of chocolate 1304 and melted in the vessel of chocolate 1304 by the vessel holding device 1300 suspending it over the hot water receptacle 1302. Also, in the example embodiment shown in FIG. 13, the vessel holding device 1300 has a square shape instead.

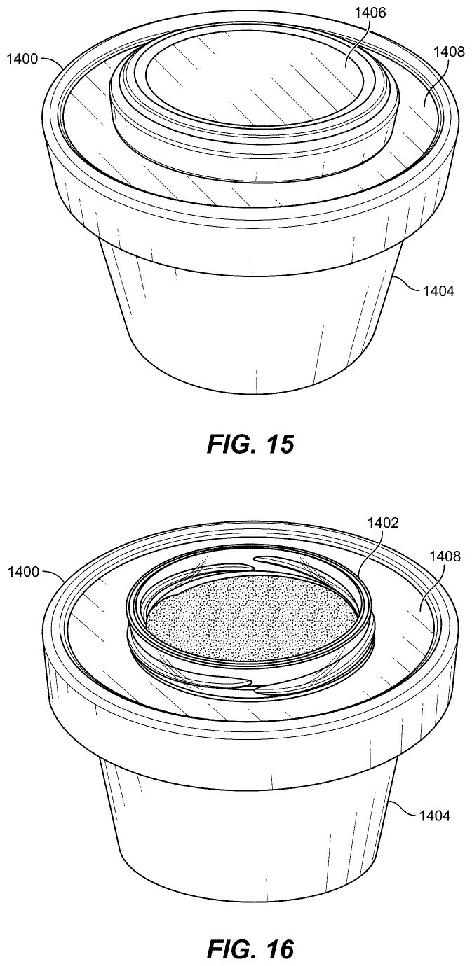

FIG. 14 illustrates a top perspective view of a vessel holding device 1400 formed from a lid of 1408 a hot water receptacle and holding a vessel of chocolate 1402 in accordance with another example embodiment of the present disclosure and FIG. 15 illustrates a top perspective view of the vessel holding device 1400 of FIG. 14 formed from a lid 1408 of the hot water receptacle 1404 that is removably placed on the hot water receptacle 1404 and is suspending the vessel of chocolate 1402 in the hot water receptacle 1404, having a lid 1406 on the vessel of chocolate 1402, in accordance with an example embodiment of the present disclosure.

FIG. 16 illustrates a top perspective view of the vessel holding device 1400 of FIG. 14 formed from a lid 1408 of the hot water receptacle 1404 that is removably placed on the hot water receptacle 1404 and is suspending the vessel of chocolate 1402 in the hot water receptacle 1404, without the lid 1406 on the vessel of chocolate 1402, in accordance with an example embodiment of the present disclosure and FIG. 17 illustrates a bottom perspective view of the vessel holding device 1400 of FIG. 14 formed from a lid 1408 of the hot water receptacle 1404 shown in FIG. 16 and holding a vessel of chocolate 1402 in accordance with another example embodiment of the present disclosure.

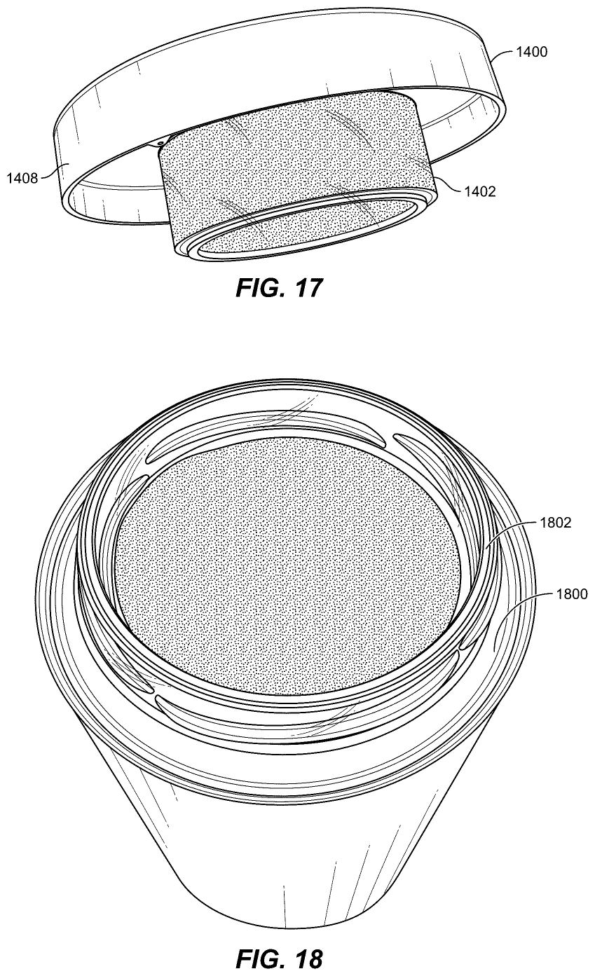

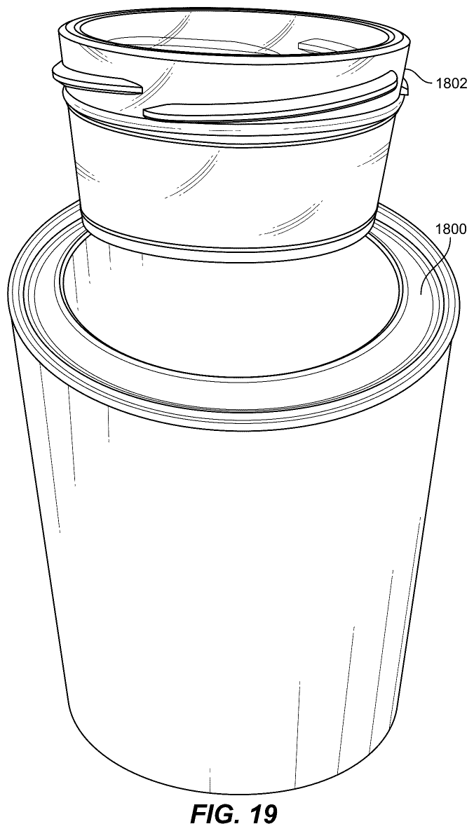

FIG. 18 illustrates a top perspective view of a vessel holding device 1800 that is a hot water receptacle and is suspending a vessel of chocolate 1802 in the hot water receptacle in accordance with another example embodiment of the present disclosure and FIG. 19 illustrates a top perspective view of the vessel holding device 1800 of FIG. 18 that is a hot water receptacle showing the vessel of chocolate 1802 being removed from the vessel holding device 1800 in accordance with an example embodiment of the present disclosure.

Some features in various embodiments of the apparatus and methods disclosed herein may include, but are not limited to: the vessel holding device 1400 sitting on top of and wrapping around the rim of the hot water receptacle 1404 like a lid with a hole in it (e.g., see the lid 1408 in FIGS. 14-17); a vessel holding device stretching across the rim of the hot water receptacle without fully covering the rim; the vessel holding device holding the vessel of chocolate through a support struts underneath the vessel that sits or attaches to the rim of the hot water receptacle (e.g., see FIGS. 5 and 6); the vessel holding device 300 (e.g., ring) being made with more than one hole to hold multiple chocolate vessels (e.g., see FIG. 3).

Note that the vessel of chocolate can be made of a variety of materials in various embodiments (glass, metal, plastic, ceramic, paper, silicone, etc).

For disposable materials, the apparatus disclosed herein may be sold with the chocolate as part of the packaging as a kit. For reusable materials the apparatus may be sold separately. In various embodiments, the apparatus may be provided or sold both ways (i.e., sold separately or as a kit with other components) regardless of the material. For example, a pack of disposable devices could be sold without chocolate and a reusable device could come in a kit with chocolate.

The vessel holding device (e.g., the vessel holding device 700 of FIG. 7) that holds the vessel of chocolate can comprise a plurality of shapes in various different embodiments, not just a circle. For example, the vessel holding device may be comprised of a three dimensional shape having side walls of various heights that are coupled to the planar surface. In an example embodiment, the shape may match the water receptacle or the chocolate vessel, such as a square tin with a square chocolate vessel on top. However, in other embodiments, the vessel holding device may be used on a variety of receptacles of various shapes in which the shape of the vessel holding device does not match the water receptacle or the chocolate vessel. Or if it sits on top of the water receptacle (e.g., a receptacle 900 like in FIGS. 7-9), it may have novel shapes for design or branding purposes, such as being tear drop or cocoa pod shaped.

Some features in various embodiments of the apparatus and methods disclosed herein may include, but are not limited to: those which do not require a special pot or machine; any water vessel with a rim approximately the size of a coffee cup; those that do not expose the user to gas fumes; those that do not expose user to risk of fire from candle or gas flame; those that are less expensive; and those that are more portable (e.g., can be made anywhere where hot water is available). In other example embodiments, the vessel of chocolate and the vessel holding device could hold a larger amount of chocolate in a water receptacle that is larger than a coffee cup, such as a bowl. Example embodiments are not limited to a coffee cup size.

The apparatus disclosed herein is more convenient than performing melting in a double boiler on the stove or in the microwave and transferring it to a serving dish.

In an example embodiment, a vessel holding device is disclosed for holding a vessel of chocolate or like substances and enabling the chocolate or like substances to be melted therein. In an example embodiment, the vessel holding device may comprise: a surface structure configured to hold the vessel; and a hole in the surface structure configured to receive part of the vessel in a downward vertical direction through the hole, wherein the surface structure has a horizontal length that is larger than a top opening of a hot water receptacle on which the surface structure is configured to be placed and in which the vessel is configured to be suspended when held by the surface structure (e.g., see FIG. 1 and FIG. 9).

The hole may be configured to hold the vessel via the hole having a size or shape that prevents the vessel from being able to pass completely down through the hole.

The surface structure may be configured to hold the vessel via a support structure affixed under the surface structure that spans across the hole under the surface structure to prevent the vessel from being able to pass completely down through the hole.

The vessel holding device may further comprise a gasket or seal affixed along a perimeter of the hole configured to make a seal between the surface structure and the vessel when the vessel is being held by the surface structure.

The vessel holding device may further comprise a gasket or seal affixed on a bottom of the surface structure configured to make a seal between the surface structure and the top opening of the hot water receptacle when the surface structure is placed on the top opening of the hot water receptacle.

The vessel holding device may further comprise the vessel in the hole, wherein: the vessel rests on a perimeter of the hole and the vessel is held by the surface structure via the hole having a size or shape that prevents the vessel from being able to pass completely down through the hole; a top portion of the vessel is vertically above the surface structure and a bottom portion of the vessel is vertically below the surface structure; and the vessel is non-porous such that it is able to hold liquid.

The vessel holding device may further comprise the hot water receptacle, wherein: the surface structure is removably placed on and at least partially covers the top opening of the hot water receptacle; and the vessel is suspended in the hot water receptacle by being held by the surface structure that is placed on the top opening of the hot water receptacle.

All or some of the surface structure may be one or more of: a circular shape, a symmetrical shape, an asymmetrical shape, a shape substantially corresponding to a shape of the top opening of the hot water receptacle; a square shape, a rectangular shape, an oblong shape, an oval shape, flat, laterally curved, vertically curved, a planar surface, and textured.

All or some of the surface structure may be made of one or more of: paper, cardboard, metal, steel, ceramic materials, glass, aluminum, alloy, plastic, rubber, silicone and other synthetic or natural solid material.

All or some of the vessel may be made of one or more of: paper, cardboard, metal, steel, ceramic materials, glass, aluminum, alloy, plastic, rubber, silicone and other synthetic or natural solid material.

All or some of the hot water receptacle is made of one or more of: paper, cardboard, metal, steel, ceramic materials, glass, aluminum, alloy, plastic, rubber, silicone and other synthetic or natural solid material.

A kit for melting chocolate or like substances is disclosed. In an example embodiment, the kit may comprise: a vessel for containing chocolate or like substances; and a surface structure configured to hold the vessel, the surface structure having a hole configured to receive part of the vessel in a downward vertical direction through the hole, wherein the surface structure has a horizontal length that is larger than a top opening of a hot water receptacle on which the surface structure is configured to be placed and in which the vessel is configured to be suspended when held by the surface structure.

The kit may further comprise the hot water receptacle.

The kit may further comprise chocolate.

In an example embodiment, a kit for melting chocolate or like substances may comprise: a vessel for containing chocolate or like substances; and a hot water receptacle for containing hot water, the hot water receptacle having a top opening configured to receive part of the vessel in a downward vertical direction through the top opening, wherein one or more of the top opening of the vessel and hot water receptacle includes a flange that enables the vessel to fit within the top opening of the hot water receptacle and the flange prevents the vessel from being able to pass completely through the top opening.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vessel holding device for holding a vessel of chocolate or like substances and enabling the chocolate or like substances to be melted therein, the vessel holding device comprising:
a surface structure configured to hold the vessel; and
a hole in the surface structure configured to receive part of the vessel in a downward vertical direction through the hole, wherein the surface structure has a horizontal length that is at least as large as a top opening of a hot water receptacle on which the surface structure is configured to be placed and in which the vessel is configured to be suspended when held by the surface structure.

2. The vessel holding device of claim 1 wherein the hole is configured to hold the vessel via the hole having a size or shape that prevents the vessel from being able to pass completely down through the hole.

3. The vessel holding device of claim 1 wherein the surface structure is configured to hold the vessel via a support structure affixed under the surface structure that spans across the hole under the surface structure to prevent the vessel from being able to pass completely down through the hole.

4. The vessel holding device of claim 1, further comprising:
a gasket or seal affixed along a perimeter of the hole configured to make a seal between the surface structure and the vessel when the vessel is being held by the surface structure.

5. The vessel holding device of claim 1, further comprising:
a gasket or seal affixed on a bottom of the surface structure configured to make a seal between the surface structure and the top opening of the hot water receptacle when the surface structure is placed on the top opening of the hot water receptacle.

6. The vessel holding device of claim 1, further comprising:
the vessel in the hole, wherein:
the vessel rests on a perimeter of the hole and the vessel is held by the surface structure via the hole having a size or shape that prevents the vessel from being able to pass completely down through the hole;
a top portion of the vessel is vertically above the surface structure and a bottom portion of the vessel is vertically below the surface structure; and
the vessel is non-porous such that it is able to hold liquid.

7. The vessel holding device of claim 6, further comprising:
the hot water receptacle, wherein:
the surface structure is removably placed on and at least partially covers the top opening of the hot water receptacle; and
the vessel is suspended in the hot water receptacle by being held by the surface structure that is placed on the top opening of the hot water receptacle.

8. The vessel holding device of claim 1, wherein all or some of the surface structure is one or more of: a circular shape, a symmetrical shape, an asymmetrical shape, a shape substantially corresponding to a shape of the top of the top opening of the hot water receptacle; a square shape, a rectangular shape, an oblong shape, an oval shape, flat, laterally curved, vertically curved, a planar surface, and textured.

9. The vessel holding device of claim 1, wherein all or some of the surface structure is made of one or more of: paper, cardboard, metal, steel, ceramic materials, glass, aluminum, alloy, plastic, rubber, silicone and other synthetic or natural solid material.

10. The vessel holding device of claim 1, wherein all or some of the vessel is made of one or more of: paper, cardboard, metal, steel, ceramic materials, glass, aluminum, alloy, plastic, rubber, silicone and other synthetic or natural solid material.

11. The vessel holding device of claim 1, wherein all or some of the hot water receptacle is made of one or more of: paper, cardboard, metal, steel, ceramic materials, glass, aluminum, alloy, plastic, rubber, silicone and other synthetic or natural solid material.

12. A kit for melting chocolate or like substances, the kit comprising:
a vessel for containing chocolate or like substances; and
a surface structure configured to hold the vessel, the surface structure having a hole configured to receive part of the vessel in a downward vertical direction through the hole, wherein the surface structure has a horizontal length that is at least as large as a top opening of a hot water receptacle on which the surface structure is configured to be placed and in which the vessel is configured to be suspended when held by the surface structure.

13. The kit of claim 12, further comprising the hot water receptacle.

14. A kit for melting chocolate or like substances, the kit comprising:
a vessel for containing chocolate or like substances; and
a hot water receptacle for containing hot water, the hot water receptacle having a top opening configured to receive part of the vessel in a downward vertical direction through the top opening, wherein one or more of the top opening of the vessel and hot water receptacle includes a flange that enables the vessel to fit within the top opening of the hot water receptacle and the flange prevents the vessel from being able to pass completely through the top opening.

15. A vessel holding device for holding a vessel in an inner perimeter that is a perimeter of a hole in the device.

16. The vessel holding device according to claim 15, which comprises:
a gasket or seal along the inner perimeter for holding the vessel; and/or
a gasket or a seal under the vessel holding device to come in contact with a hot water receptacle on which the vessel holding device is placed.

17. The vessel holding device according to claim 15 which has support struts underneath the device to cradle the vessel.

18. The vessel holding device according to claim 15 which has one of a plurality of shapes for the inner perimeter and one of a plurality of shapes for an outer perimeter of the device.

19. The vessel holding device according to claim 15 in which:
the device is formed from a lid of a hot water receptacle to make contact with the hot water receptacle.
